(19) United States
(12) Patent Application Publication
(10) Pub. No.: US 2021/0156706 A1
(43) Pub. Date: May 27, 2021

(54) INFORMATION PROVISION SYSTEM, INFORMATION PROVISION DEVICE, AND INFORMATION PROVISION PROGRAM

(71) Applicant: TOYOTA JIDOSHA KABUSHIKI KAISHA, Toyota-shi (JP)

(72) Inventor: Akira SASAKI, Miyoshi-shi (JP)

(73) Assignee: TOYOTA JIDOSHA KABUSHIKI KAISHA, Toyota-shi (JP)

(21) Appl. No.: 16/984,573

(22) Filed: Aug. 4, 2020

(30) Foreign Application Priority Data
Nov. 25, 2019 (JP) 2019-212271

(51) Int. Cl. G01C 21/36

(52) U.S. Cl. CPC G01C 21/367; G01C 21/3676; G01C 21/3694

(57) ABSTRACT

An information provision system includes a vehicle including a first processor having a hardware, and a server device that includes a second processor having a hardware, and is operable to communicate with the vehicle for transmission of information via communication lines. The second processor obtains position information of the vehicle via the communication lines, and sends driving characteristic information of vehicles in a region that lies within a range of a first predetermined distance from a position of the vehicle, to the vehicle, via the communication lines, based on the obtained position information. The first processor presents the driving characteristic information transmitted from the server device, to a driver of the vehicle.

### INCORPORATION BY REFERENCE

The disclosure of Japanese Patent Application No. 2019-212271 filed on Nov. 25, 2019 including the specification, drawings and abstract is incorporated herein by reference in its entirety.

### BACKGROUND

### 1. Technical Field

The disclosure relates to an information provision system, an information provision device, and an information provision program.

### 2. Description of Related Art

A navigation system described in Japanese Unexamined Patent Application Publication No. 2010-112732 (JP 2010-112732 A) changes the degree of priority with which regional information is highlighted, according to the content displayed.

### SUMMARY

In each geographical region, there may be vehicle driving characteristics (driving tendencies, driving manners) unique to the region. Examples of the driving characteristics include “Nagoya driving” seen in and around Nagoya city, Aichi prefecture, and no need to temporarily stop in front of a railroad crossing (in the U.S.). Thus, when a driver drives a vehicle in the region without being aware of the driving characteristics of vehicles in the region, the driver may be embarrassed or feel anxiety.

The disclosure provides an information provision system, information provision device, and information provision program, which can call for attention according to vehicle driving characteristics unique to a region.

An information provision system according to this disclosure includes a vehicle including a first processor having a hardware, and a server device including a second processor having a hardware. The server device is operable to communicate with the vehicle for transmission of information via communication lines. The second processor is configured to obtain position information of the vehicle via the communication lines, and send driving characteristic information of vehicles in a region that lies within a range of a first predetermined distance from a position of the vehicle, to the vehicle, via the communication lines, based on the obtained position information. The first processor is configured to present the driving characteristic information transmitted from the server device, to a driver of the vehicle.

An information provision device according to the disclosure includes a processor having a hardware. The processor is configured to obtain position information of a vehicle via communication lines, and send driving characteristic information of vehicles in a region that lies within a range of a first predetermined distance from a position of the vehicle, to the vehicle, via the communication lines, based on the obtained position information.

An information provision program according to the disclosure causes a processor having a hardware to obtain position information of a vehicle via communication lines, and send driving characteristic information of vehicles in a region that lies within a range of a first predetermined distance from a position of the vehicle, to the vehicle, via the communication lines, based on the obtained position information.

According to the disclosure, it is possible to call for attention according to vehicle driving characteristics unique to the region.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of an information provision system according to one embodiment of the disclosure;

FIG. 2 is a view showing one example of driving characteristic data stored in a driving characteristic database shown in FIG. 1;

FIG. 3 is a timing chart showing an information providing process according to one embodiment of the disclosure;

FIG. 4 is a flowchart illustrating an attention seeking process shown in FIG. 3;

FIG. 5 is a schematic diagram showing a display example of driving characteristic information;

FIG. 6 is a flowchart illustrating a modified example of the attention seeking process shown in FIG. 3; and

FIG. 7 is a block diagram showing the configuration of a modified example of the information provision system shown in FIG. 1.

### DETAILED DESCRIPTION OF EMBODIMENTS

Referring to the drawings, an information provision system as one embodiment of the disclosure will be described in detail.

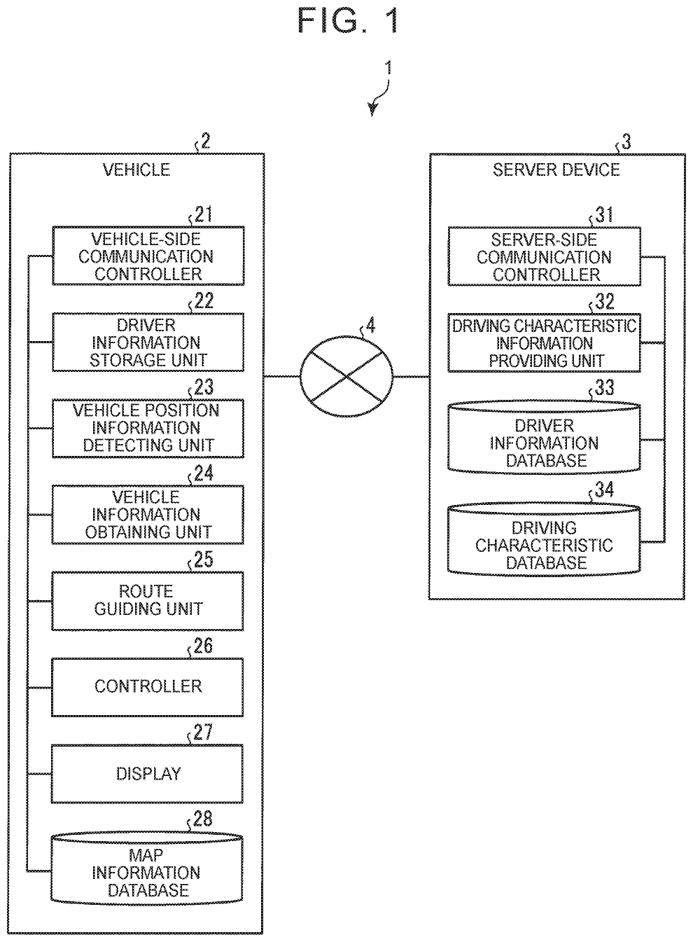

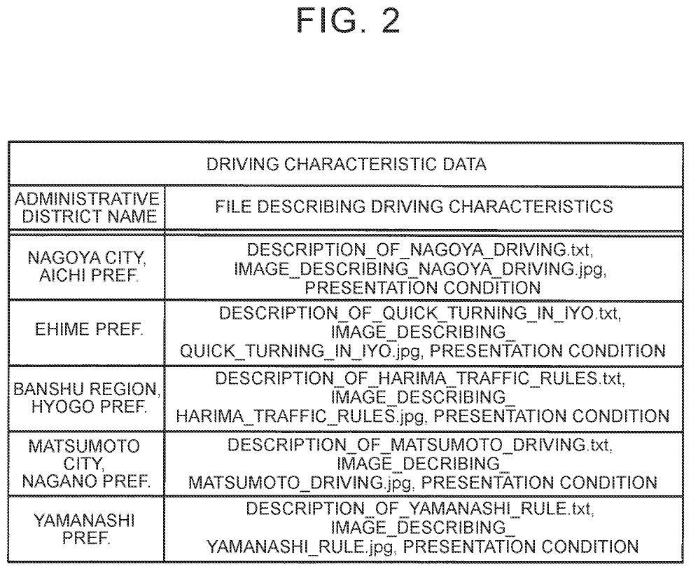

Initially, the information provision system 1 as one embodiment of the disclosure will be described with reference to FIG. 1 and FIG. 2.

FIG. 1 is a block diagram showing the configuration of the information provision system 1 as one embodiment of the disclosure. FIG. 2 shows one example of driving characteristic data stored in a driving characteristic database 34 shown in FIG. 1.

As shown in FIG. 1, the information provision system 1 includes a vehicle 2 and a server device 3 as main constituent elements, and the vehicle 2 and the server device 3 are configured to be able to communicate with each other for transmission of information, via communications lines 4, such as those of the Internet network or a mobile telephone network.

The vehicle 2 is one of known vehicles including an electric vehicle (EV), hybrid vehicle (HV), fuel cell electric vehicle (FCEV), and so forth, and includes a vehicle-side communication controller 21, driver information storage unit 22, vehicle position information detecting unit 23, vehicle information obtaining unit 24, route guiding unit 25, controller 26, display 27, and map information database 28.

The vehicle-side communication controller 21 is a device that controls information communications with the server device 3 via the communication lines 4. More specifically, the vehicle-side communication controller 21 receives a variety of information transmitted from the server device 3 via the communication lines 4, and sends a variety of information to the server device 3 via the communication lines 4. As the vehicle-side communication controller 21, a communicating means for DCM (Data Communication Module) or a communicating means for performing information communications using a mobile wireless communication network may be employed.

The driver information storage unit 22 is provided by a non-volatile storage device, and stores information on a driver who drives the vehicle 2. The information on the driver, which is stored in the driver information storage unit 22, includes identification information specific to the driver, hometown, present address, information concerning the presence or absence of vehicle driving experience for each administrative district, and so forth.

The vehicle position information detecting unit 23 is a device that receives radio waves from GPS (Global Positioning System) satellites, so as to detect position information of the vehicle 2. As a method of detecting the position information of the vehicle 2, a method that combines LiDAR (Light Detection and Ranging, Laser Imaging Detection and Ranging) with a three-dimensional digital map may also be employed.

The vehicle information obtaining unit 24 is a device that obtains a variety of information concerning conditions of the vehicle 2. As examples of the information concerning conditions of the vehicle 2 obtained by the vehicle information obtaining unit 24, an operating state of a direction indicator, operating state of a braking device, operating state of a steering device, operating state of the accelerator pedal, and the traveling speed of the vehicle 2 may be listed.

The route guiding unit 25 is a device that performs guiding through a route to a destination set by using map information stored in the map information database 28.

The controller 26 includes a processor having hardware, such as CPU (central processing unit), DSP (digital signal processor), or FPGA (field-programmable gate array), and a storage unit, such as RAM (random access memory) and ROM (read-only memory). The controller 26 loads a computer program stored in the storage unit into a workspace of the storage unit, and controls each part of the vehicle 2 by executing the computer program.

The display 27 is in the form of a liquid crystal display or an organic EL display, for example, and displays a variety of information according to a control signal from the controller 26.

The map information database 28 contains map information. Here, the map information is information necessary to specify the positions of roads, road structures, facilities, etc., and includes, for example, data (e.g., node ID, coordinates, etc.) concerning each node set on roads, data (e.g., link ID, link name, connection node ID, road coordinates, road type (toll road or general road), the number of lanes, etc.) concerning each link set on roads, and feature data (e.g., traffic lights, road signs, guardrails, facilities, etc.).

The server device 3 is provided by an information-processing device capable of performing various information processing, using a cloud computing technology or an edge computing technology, and includes a server-side communication controller 31, driving characteristic information providing unit 32, driver information database 33, and driving characteristic database 34. The functions of the server-side communication controller 31 and the driving characteristic information providing unit 32 are implemented by a processor including an information-processing device, which loads computer programs stored in the storage unit into a workspace of the storage unit, and executes the computer programs.

The server-side communication controller 31 is a device that controls information communications with the vehicle 2 via the communication lines 4. More specifically, the server-side communication controller 31 receives a variety of information transmitted from the vehicle 2 via the communication lines 4, and sends a variety of information to the vehicle 2 via the communication lines 4. As the server-side communication controller 31, a communication means for DCM or a communication means that conducts information communications using a mobile wireless communication network may be employed.

The driving characteristic information providing unit 32 performs an information providing process as described later, so as to provide information concerning vehicle driving characteristics (driving tendencies or habits, driving manners) for each administrative district, to the driver of the vehicle 2, via the communication lines 4.

The driver information database 33 contains driver information obtained by communicating with the vehicle 2 via the communication lines 4 at intervals of a given control period, and stored in the driver information storage unit 22, such that the driver information can be identified for each driver.

The driving characteristic database 34 contains information (driving characteristic data) concerning vehicle driving characteristics for each administrative district. More specifically, as shown in FIG. 2, the driving characteristic database 34 contains, as driving characteristic data for each administrative district, a text file and an image file both describing driving characteristics of vehicles in the corresponding administrative district, and a rule file indicating a condition or conditions under which the information concerning the vehicle driving characteristics is presented to the driver of the vehicle 2. For example, vehicle driving characteristics called “Nagoya driving” (notorious driving behaviors unique to Nagoya residents) are occasionally seen in and around Nagoya city, Aichi prefecture. Examples of the “Nagoya driving” include cases where (1) a driver does not operate the direction indicator when changing lanes, (2) a driver of a vehicle on a right-turn lane tries to pass a leading or preceding vehicle that is waiting for the right time for turning right on the same right-turn lane, etc. As driving characteristic data, a text file and/or image file describing the “Nagoya driving”, and a rule file indicating a condition (such as when the vehicle changes lanes, or turns right) under which the information concerning the “Nagoya driving” is presented, are stored. Other than the “Nagoya driving”, “Quick turning in Iyo” in Ehime prefecture, “Harima traffic rules” in Banshu region of Hyogo prefecture, “Matsumoto driving” in Matsumoto, Nagano prefecture, and “Yamanashi rule” in Yamanashi prefecture are well known as driving characteristics of vehicles in each administrative district.

The driving characteristic data for each administrative district can be created by analyzing position information and behavior information (e.g., the vehicle speed, inter-vehicle distance, and operation timing of the direction indicator) of vehicles obtained by vehicle traveling data recorders, probe vehicles, and road-vehicle communications, for example, using artificial intelligence, or the like, and extracting distinctive vehicle driving characteristics in each administrative district. In this embodiment, the vehicle driving characteristics are stored for each administrative district, but the unit for which vehicle driving characteristics are stored is not limited to the administrative district, and driving characteristics may be stored for any given district (or region).

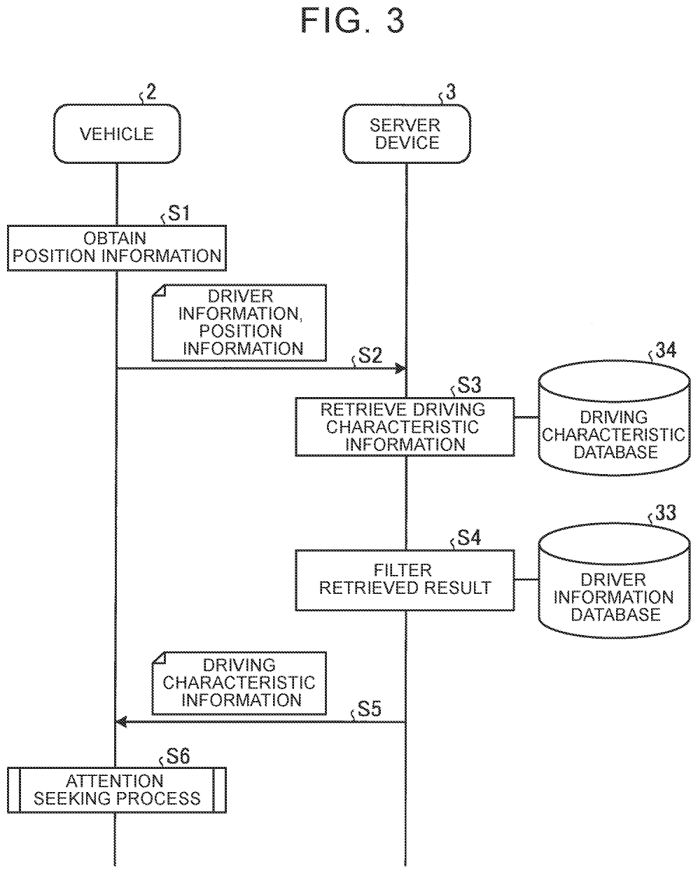

In the information provision system 1 configured as described above, the server device 3 performs an information providing process as indicated below, so as to call for attention according to the vehicle driving characteristics unique to the administrative district in question; as a result, the driver is less likely or unlikely to be embarrassed or feel anxiety when he/she drives the vehicle 2 without being aware of the driving characteristics of vehicles in the administrative district. Referring now to FIG. 3 to FIG. 6, operation of the server device 3 when it performs the information providing process will be described.

FIG. 3 is a timing chart showing the information providing process according to one embodiment of the disclosure. The information providing process shown in the timing chart of FIG. 3 starts and goes to step S1 when the ignition switch of the vehicle 2 is switched from the OFF state to the ON state. The information providing process is repeatedly executed each time a given length of time elapses from when the last cycle of the information providing process ends, while the ignition switch of the vehicle 2 is in the ON state. Operation of the controller 26 as indicated below is carried out when the controller 26 executes a computer program.

In step S1, the controller 26 controls the vehicle position information detecting unit 23 so as to obtain position information of the vehicle 2. Thus, the task of step S1 is completed, and the information providing process goes to step S2.

In step S2, the controller 26 reads identification information of the driver of the vehicle 2 from the driver information storage unit 22. Then, the controller 26 controls the vehicle-side communication controller 21, so as to send the position information of the vehicle 2 obtained in step S1 and the identification information of the driver of the vehicle 2 thus read, to the server device 3, via the communication lines 4. Thus, the task of step S2 is completed, and the information providing process goes to step S3.

In step S3, the server-side communication controller 31 receives the position information of the vehicle 2 and the identification information of the driver transmitted from the vehicle 2 via the communication lines 4. Then, the driving characteristic information providing unit 32 searches the driving characteristic database 34 for driving characteristic data of an administrative district that lies within a range of a first predetermined distance from the position of the vehicle 2, based on the received position information of the vehicle 2. When none of the administrative districts of which the driving characteristic data are stored is within the range of the first predetermined distance from the position of the vehicle 2, the driving characteristic information providing unit 32 finishes the information providing process. Thus, the task of step S3 is completed, and the information providing process goes to step S4.

In step S4, the driving characteristic information providing unit 32 reads driver information corresponding to the identification information of the driver received in step S3, from the driver information database 33. Then, the driving characteristic information providing unit 32 performs filtering on the driving characteristic data retrieved in step S3, using the driver information thus read. More specifically, when the administrative district corresponding to the retrieved driving characteristic data is within a range of a second predetermined distance from the hometown or present address of the driver, or when the driver has an experience of driving in the past in the administrative district corresponding to the retrieved driving characteristic data, the driving characteristic information providing unit 32 filters out the retrieved driving characteristic data from objects of processing as described below. Through this task, attention-seeking operation suitable for the driver can be performed. When a predetermined period of time or longer elapses from the time when the driver drove in the past in the administrative district corresponding to the retrieved driving characteristic data, the driving characteristic information providing unit 32 may include the retrieved driving characteristic data in the objects of processing as described below. Thus, the task of step S4 is completed, and the information providing process proceeds to step S5.

In step S5, the driving characteristic information providing unit 32 controls the server-side communication controller 31, so as to send driving characteristic data for each administrative district which has been subjected to filtering in step S4, as driving characteristic information, to the vehicle 2, via the communication lines 4. Thus, the task of step S5 is completed, and the information providing process goes to step S6.

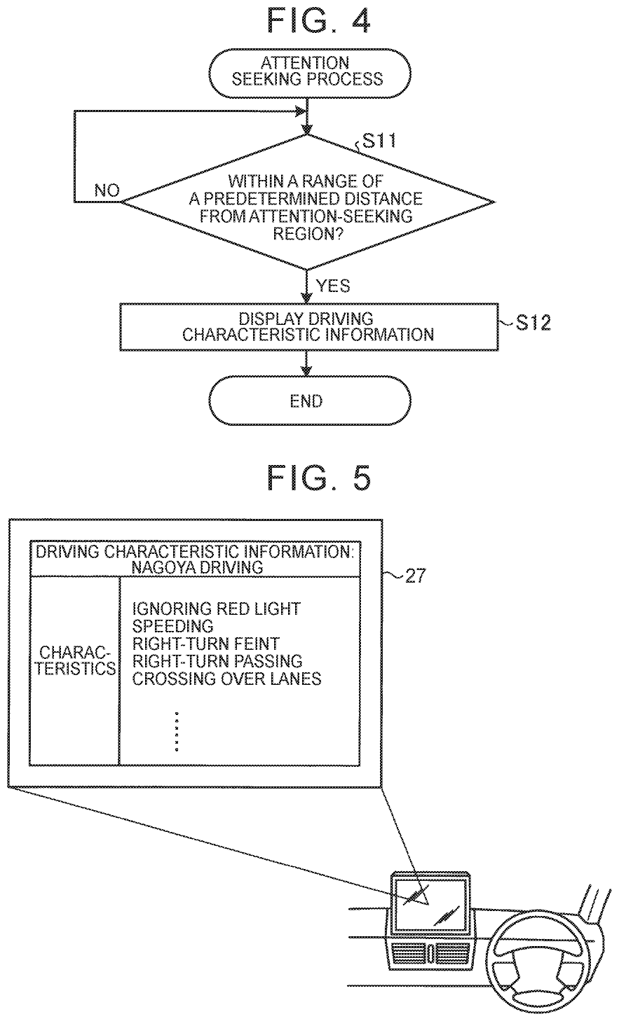

In step S6, the vehicle-side communication controller 21 receives driving characteristic information transmitted from the server device 3 via the communication lines 4. Then, the controller 26 performs an attention seeking process as shown in FIG. 4, so as to present the driving characteristic information transmitted from the server device 3, to the driver of the vehicle 2. Thus, the task of step S6 is completed, and the information providing process ends.

FIG. 4 is a flowchart showing the attention seeking process shown in FIG. 3. The attention seeking process shown in the flowchart of FIG. 4 starts and goes to step S1l when the vehicle-side communication controller 21 receives the driving characteristic information transmitted from the server device 3 via the communication lines 4.

In step S11, the controller 26 controls the vehicle position information detecting unit 23 so as to obtain the position information of the vehicle 2. Then, the controller 26 determines whether the current position of the vehicle 2 is within a range (attention-seeking region) of a third predetermined distance from the administrative district of which the driving characteristic data was transmitted, based on the driving characteristic information transmitted from the server device 3 and the position information of the vehicle 2. When the controller 26 determines that the current position of the vehicle 2 is within the attention-seeking region (step S11: YES), the controller 26 proceeds to step S12 of the attention seeking process. On the other hand, when the current position of the vehicle 2 is not within the attention-seeking region (step S11: NO), the controller 26 executes step S11 again after a lapse of a predetermined time. The controller 26 counts the number of times of execution of step S11, and finishes the attention seeking process when the count value becomes equal to or larger than a predetermined value.

In step S12, the controller 26 displays the driving characteristic information transmitted from the server device 3 on the display 27, as shown in FIG. 5 by way of example, so as to call for attention according to the vehicle driving characteristics unique to the administrative district. With this configuration, the driver is less likely or unlikely to be embarrassed or feel anxiety when he/she drives the vehicle 2 without being aware of the driving characteristics of vehicles in the administrative district. In this embodiment, the driving characteristic information is displayed at the time when the current position of the vehicle 2 falls in the attention-seeking region. However, the driving characteristic information may be displayed at the time when the driving characteristic information is received from the server device 3. Also, the controller 26 may display the driving characteristic information on an information communication terminal carried by the driver. Further, the controller 26 may present the driving characteristic information to the driver with voice. Thus, the task of step S12 is completed, and the attention seeking process ends.

As is apparent from the above description, in the information provision system 1 as one embodiment of the disclosure, the server device 3 obtains position information of the vehicle 2 via the communication lines 4, and sends driving characteristic information of vehicles in the administrative district that lies in the range of the predetermined distance from the position of the vehicle 2, to the vehicle 2, via the communication lines 4, based on the obtained position information. Then, the vehicle 2 presents the driving characteristic information transmitted from the server device 3, to the driver of the vehicle 2, so as to call for attention according to the vehicle driving characteristics unique to the administrative district.

When the vehicle driving characteristic information is received from the server device 3, and a destination of route guiding is set, the route guiding unit 25 may guide the driver through a route that reaches the destination without passing the administrative district corresponding to the received driving characteristic information. With this configuration, it is possible to guide the driver of the vehicle 2 through the route to the destination, without making the driver embarrassed or feel anxiety.

### First Modified Example

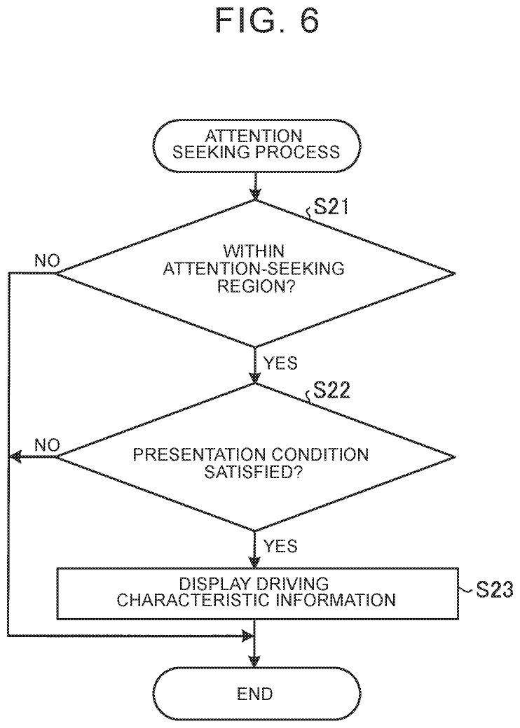

FIG. 6 is a flowchart showing a modified example of the attention seeking process shown in FIG. 3. The attention seeking process shown in the flowchart of FIG. 6 starts and goes to step S21 when the vehicle-side communication controller 21 receives driving characteristic information transmitted from the server device 3 via the communication lines 4.

In step S21, the controller 26 controls the vehicle position information detecting unit 23 so as to obtain position information of the vehicle 2. Then, the controller 26 determines whether the current position of the vehicle 2 is within the range (attention-seeking region) of the third predetermined distance from the administrative district of which the driving characteristic data was transmitted, based on the driving characteristic information transmitted from the server device 3 and the position information of the vehicle 2. When the controller 26 determines that the current position of the vehicle 2 is within the attention-seeking region (step S21: YES), the controller 26 proceeds to step S22 of the attention seeking process. On the other hand, when the current position of the vehicle 2 is not within the attention-seeking region (step S21: NO), the controller 26 finishes the attention seeking process.

In step S22, the controller 26 obtains information concerning conditions of the vehicle 2 via the vehicle information obtaining unit 24. Then, the controller 26 determines, based on the obtained information, whether the conditions of the vehicle 2 satisfy a presentation condition included in the driving characteristic information. For example, when the presentation condition is that the vehicle 2 is turning right, the controller 26 determines whether the direction indicator is operated in the right direction. When the presentation condition is a condition concerning the position of the vehicle 2, for example, a condition that the vehicle 2 is located on a right-turn lane, the controller 26 determines whether the presentation condition is satisfied based on the position information of the vehicle 2. When the controller 26 determines that the presentation condition is satisfied (step S22: YES), the controller 26 proceeds to step S23 of the attention seeking process. On the other hand, when the presentation condition is not satisfied (step S22: NO), the controller 26 finishes the attention seeking process.

In step S23, the controller 26 displays the driving characteristic information transmitted from the server device 3, on the display 27, so as to call for attention according to the vehicle driving characteristics unique to the administrative district. With this configuration, the driver is less likely or unlikely to be embarrassed or feel anxiety when he/she drives the vehicle 2 without being aware of the vehicle driving characteristics in the administrative district. The controller 26 may display the driving characteristic information on an information communication terminal carried by the driver. Further, the driving characteristic information may be presented to the driver with voice. Thus, the task of step S23 is completed, and the attention seeking process ends.

As is apparent from the above description, in this modified example, the driving characteristic information is displayed when the conditions of the vehicle 2 satisfy the presentation condition; therefore, it is possible to more appropriately call for attention according to the conditions of the vehicle 2.

### Second Modified Example

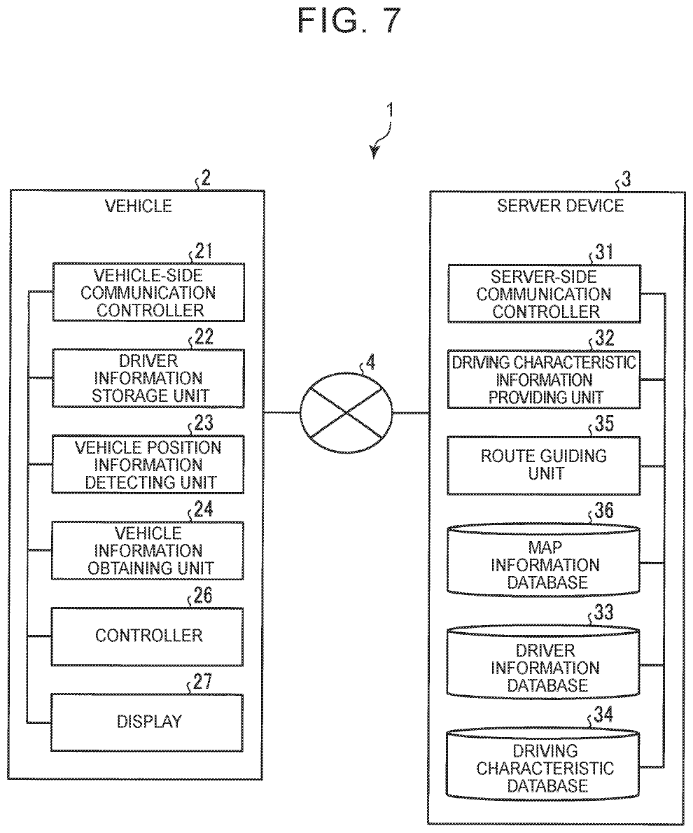

FIG. 7 is a block diagram showing the configuration of a modified example of the information provision system shown in FIG. 1. As shown in FIG. 7, in this modified example, the server device 3 includes a route guiding unit 35 and a map information database 36. The route guiding unit 35 and the map information database 36 have the same configuration as the route guiding unit 25 and map information database 28 shown in FIG. 1. With this configuration, the server device 3 can guide the vehicle 2 through a route by sending route guide information to the vehicle 2 via the communication lines 4.

Further effects and modified examples can be easily derived from those skilled in the art. Broader aspects of this disclosure have been illustrated above, and are not limited to the particular details and typical embodiments as described above. Thus, it is possible to make various changes to the embodiments, without departing from the concept or range of the overall disclosure defined by the appended claims and their equivalents.

What is claimed is:

1. An information provision system comprising:
a vehicle including a first processor having a hardware; and
a server device including a second processor having a hardware, the server device being operable to communicate with the vehicle for transmission of information via communication lines, wherein
the second processor is configured to obtain position information of the vehicle via the communication lines, and send driving characteristic information of vehicles in a region that lies within a range of a first predetermined distance from a position of the vehicle, to the vehicle, via the communication lines, based on the obtained position information, and
the first processor is configured to present the driving characteristic information transmitted from the server device, to a driver of the vehicle.

2. The information provision system according to claim 1, wherein the second processor is configured to perform filtering on the driving characteristic information transmitted to the vehicle, based on driver information of the vehicle.

3. The information provision system according to claim 2, wherein the second processor is configured to inhibit transmission of the driving characteristic information of vehicles in the region, when a hometown of the driver of the vehicle is within a range of a second predetermined distance from the region.

4. The information provision system according to claim 2, wherein the second processor is configured to inhibit transmission of the driving characteristic information of vehicles in the region, when an address of the driver of the vehicle is within a range of a third predetermined distance from the region.

5. The information provision system according to claim 2, wherein the second processor is configured to inhibit transmission of the driving characteristic information of vehicles in the region, when the driver of the vehicle has an experience of driving in the region.

6. The information provision system according to claim 1, wherein the first processor is configured to present the driving characteristic information to the driver of the vehicle when the vehicle enters a range of a fourth predetermined distance from the region.

7. The information provision system according to claim 1, wherein the first processor is configured to present the driving characteristic information to the driver of the vehicle when the first processor receives the driving characteristic information from the server device.

8. The information provision system according to claim 1, wherein the first processor is configured to present the driving characteristic information to the driver of the vehicle when a state of the vehicle satisfies a presentation condition under which the driving characteristic information is presented.

9. The information provision system according to claim 1, wherein, when a destination of a route used for guiding is set, the first processor is configured to guide the vehicle through the route to the destination without passing the region.

10. The information provision system according to claim 1, wherein the vehicle has a display device, and the first processor is configured to display the driving characteristic information transmitted from the server device, on the display device.

11. An information provision device comprising a processor having a hardware, wherein the processor is configured to obtain position information of a vehicle via communication lines, and send driving characteristic information of vehicles in a region that lies within a range of a first predetermined distance from a position of the vehicle, to the vehicle, via the communication lines, based on the obtained position information.

12. The information provision device according to claim 11, wherein the processor is configured to perform filtering on the driving characteristic information transmitted to the vehicle, based on driver information of the vehicle.

13. The information provision device according to claim 12, wherein the processor is configured to inhibit transmission of the driving characteristic information of vehicles in the region, when a hometown of a driver of the vehicle is within a range of a second predetermined distance from the region.

14. The information provision device according to claim 12, wherein the processor is configured to inhibit transmission of the driving characteristic information of vehicles in the region, when an address of a driver of the vehicle is within a range of a third predetermined distance from the region.

15. The information provision device according to claim 12, wherein the processor is configured to inhibit transmission of the driving characteristic information of vehicle in the region, when a driver of the vehicle has an experience of driving in the region.

16. An information provision program that causes a processor having a hardware to:
obtain position information of a vehicle via communication lines; and
send driving characteristic information of vehicles in a region that lies within a range of a first predetermined distance from a position of the vehicle, to the vehicle, via the communication lines, based on the obtained position information.

17. The information provision program according to claim 16, which causes the processor to perform filtering on the driving characteristic information transmitted to the vehicle, based on driver information of the vehicle.

18. The information provision program according to claim 17, which causes the processor to inhibit transmission of the driving characteristic information of vehicles in the region, when a hometown of a driver of the vehicle is within a range of a second predetermined distance from the region.

19. The information provision program according to claim 17, which causes the processor to inhibit transmission of the driving characteristic information of vehicles in the region, when an address of a driver of the vehicle is within a range of a third predetermined distance from the region.

20. The information provision program according to claim 17, which causes the processor to inhibit transmission of the driving characteristic information of vehicles in the region, when a driver of the vehicle has an experience of driving in the region.
